(19) United States
(12) Patent Application Publication
(10) Pub. No.: US 2016/0289462 A1
(43) Pub. Date: Oct. 6, 2016

(54) Polymers for Making Superhydrophobic Surfaces

(71) Applicant: AGENCY FOR SCIENCE, TECHNOLOGY AND RESEARCH, Connexis, Singapore (SG)

(72) Inventors: Liang Hong, Singapore (SG); Siok Wei Tay, Singapore (SG); Pramoda Kumari Pallathadka, Singapore (SG); Yeap Hung Ng, Singapore (SG)

(21) Appl. No.: 15/026,930

(22) PCT Filed: Sep. 26, 2014
(86) PCT No.: PCT/SG2014/000456

§ 371 Date: Apr. 1, 2016

(30) Foreign Application Priority Data
Sep. 26, 2013 (SG) 201307255-8

(51) Int. Cl. C09D 5/16; C09D 133/14; C09D 125/14; C08F 212/08; C08F 220/32

(52) U.S. Cl. CPC C09D 5/1668; C08F 212/08; C08F 220/32; C09D 125/14; C09D 133/14; C08F 2220/325

(57) ABSTRACT

The present disclosure relates to a process for making a comb-like polymer comprising the following steps of reacting an epoxy-functionalized monomer with a nucleophile comprising a C₈-C₂₀-alkyl group or halogen substituted C₈-C₂₀-alkyl group in the presence of an aqueous medium and polymerizing the reaction product. The comb-like polymer has functional groups on its backbone and long hydrophobic side chains. It can even be produced as a shell on a submicron sphere according to an alternative process according to the invention. The polymers obtainable by the inventive process can be polymerized with polyurethane prepolymers to achieve coating surfaces that show superhydrophobicity (see FIG.). Such coatings can have numerous applications especially in the aircraft industry for paints used on the airplane wings, because they avoid water droplet building.

### TECHNICAL FIELD

The present invention generally relates to methods for making polymers that have a use in coating applications. The present invention specifically relates to comb-like polymers made according to the inventive process and their use in developing new superhydrophobic (SHP) surface coatings.

### BACKGROUND

Superhydrophobicity or lotus effect is the ability of the surface to repel water completely. A superhydrophobic surface has a contact angle close to or higher than 150° and a contact angle hysteresis of less than 10°. On such surface, water can form a perfect spherical drop and can be rolled off even on horizontal surface. The best example of such surfaces could be found in nature. Lotus leaf, for one, possesses both nano and microstructures that made the surface barely wettable.

It is desirable to mimic such phenomena as such modified devices can find important applications in many industries such as the aviation and automobile industries.

There are two main factors contributing to superhydrophobicity, namely surface energy and surface morphology. High-energy surfaces interact more strongly with water droplet than low energy surfaces, increasing adhesion and wetting. Thus, in general, superhydrophobicity could be achieved by lowering the surface energy which could be achieved by various methods such as applying a layer of low surface energy material. Surface morphology has a significant impact on the hydrophobicity. Roughness of the surface will accentuate the effects of both low energy and high energy surfaces by making them more hydrophobic and hydrophilic respectively.

Contemporary research activities aiming to achieve practically viable and state-of-the-art superhydrophobic surface focus on microstructuring and nanostructuring on a candidate surface as well as advanced hydrophobic treatment of a structured surface.

Both unordered and ordered surface structures are known. The more common method of obtaining superhydrophobicity derived from unordered structure is commonly reported via incorporation of fillers with a wide size distribution. Common fillers are SiO₂, TiO₂, carbon nanotubes, etc. Besides unordered structures, structured surfaces are also reported with superhydrophobic properties. Hierarchic levels of rows and ridges or parallel grooves, microsteps are for instance fabricated to obtain surface anisotropic geometry.

For hydrophobic treatment of structured surface, methods, such as silanisation or usage of hydrophobic moieties like fluorinated or dimethyl siloxane segments, have been reported.

All these methods are not fully satisfactory with the regard to the level of SHP achieved or lack an ability to be up scalable to be used in industrial application such as in the car or airplane making industries which have a high need of these materials in applications where water repellent surfaces are necessary.

Therefore, there is a need to make SHP surfaces by using new materials in the respective coating technologies. Especially materials to make polyurethane coatings with SHP capabilities are desired which not only have the desired hydrophobicity, but are also stable in their use applications and can imbed hydrophobicity improving additives.

### SUMMARY

In a first aspect, there is provided a process for making a comb-like polymer comprising the following steps:

(a)reacting an epoxy-functionalized monomer with a nucleophile carrying a C₈-C₂₀ alkyl group or halogen substituted C₈-C₂₀ alkyl group in an aqueous medium; and

(b) polymerizing the reaction product in-situ.

The method allows for making new comb-like polymers. The reaction of the nucleophile with a long alkyl chain with the epoxy group under a ring opening was achieved by running the reaction in an aqueous medium. Surprisingly it has been found that the alkylation with the long alkyl chain is possible under these conditions while it appears impossible in most organic solvents. Steric shielding of the nucleophilic alkyl group was not found under the inventive conditions and the monomer could be alkylated. The alkylated monomer can then be polymerized to a chain having alkyl branches. A comb-like polymer is therefore obtained according to the invention. Advantageously the aqueous medium makes acid catalysis viable and effective. The structure (e.g. the alkylation degree) of the comb-like polymer can be varied by controlling the pH in acidic or neutral medium or adding different salts.

According to an alternative embodiment is also possible to produce submicron sphere with a comb-like polymer shell using a co-polymerization with another polymer monomer in step (b) followed by a phase inversion.

In a second aspect, a comb-like polymer is obtainable by the inventive process which has preferable characteristics. According to the invention, a novel functional (or reactive) comb-like polymer structure possessing a hydrophilic backbone bearing hydroxyl, secondary amino and epoxide groups as well as a hydrophobic long side chains has been found. The reactive main chain makes it different from the polymers of long alkyl acrylate that has similar comb-like chain structure, but has no reactive areas, in the main chain. The presence of reactive functional groups in main chain is critical in achieving a desired adhesion through chemical bonding between the main-chain with a substrate, when the polymer is used to modify a surface or coating polymer of interest with a hydrophobic surface introduced by the long alkyl chains.

Advantageously, the comb-like polymer can be chemically bonded via the hydrophilic backbone groups with the polyurethane coating.

In a third aspect there have been provided submicron spheres with a shell of a comb-like polymer obtainable in alternative embodiment of the reaction. The submicron sphere can have a core-shell structure with polymer core and a shell. The alkyl side chains can be pulled out of the surface shell through phase inversion treatment. As a result, the resulting submicron spheres are surface enriched by the alkyl side chains (“hairy sphere”). They provide interesting structural features which can be utilized. For instance they can be integrated with the linear comb-like polymers to fabricate a rough soft SHP surface of polyurethane.

In a fourth aspect there is provided another process for making a comb-like polymer comprising the following steps

(b) polymerizing an epoxy-functionalized monomer optionally in the presence of another monomer to form a polymer or co-polymer; and

(a) reacting the polymer or co-polymer with a nucleophile comprising an C₈-C₂₀-alkyl group or halogen substituted C₈-C₂₀-alkyl group in an emulsion.

This process is an alternative to make the inventive comb-like polymers. By use of a suitable co-polymer submicron spheres in the form of “hairy spheres” can be made.

In a fifth aspect, there is disclosed the use of the comb-like polymer according to the invention in a coating process characterized in that a polyurethane pre-polymer is cured in the presence of the comb-like polymer.

In a sixth aspect, there is accordingly provided the disclosure of a coating obtainable in the coating process. The coating surface shows SHP due to the introduction of the long alkyl chains by the comb-like polymer. A SHP surface on the polyurethane was achieved with a water contact angle (WCA) between 140 and 150 degree and a hysteresis angle below 10 degree (see FIG. 1). Due to the chemical bonding of those groups a good adhesion is achieved so that it can be expected that the SHP is maintained over long periods of time. The invention allows for the incubation of a SHP surface through evolving a thin hydrophobic polymer film on a commercial aerospace PU coating. Incompatible nature between a superhydrophobic polymer and the polyurethane (PU) matrix is, therefore, a challenge that has been overcome according to the invention. The inventive coating shows good adhesion and attains a uniform coverage. A gradient implantation of the comb-like polymers as described in the detailed embodiments can even more improve the SHP surface.

In a seventh aspect, there is provided the use of a coating according to the invention as top coat on aircraft wings or as water repellent surface coating of pipes or ship bodies. In these applications the advantageous features of the inventive coatings can be utilized to improve the lifetime of the SHP effect and ensure a good adhesion.

### Definitions

The following words and terms used herein shall have the meaning indicated:

The term “superhydrophobic surfaces” as used herein refer to hydrophobic surfaces that have contact angles greater than 150° while generally simple hydrophobic surfaces have contact angles greater than 90°, but not reaching this value.

The term “comb-like polymer” as used herein refers to polymers having one or more polymer backbone chains from which side chains are branched off. In this invention the side chains are hydrophobic, long and optionally halogen-substituted alkyl chains.

The term “curing” as used herein refers to the toughening or hardening of a polymer material by cross-linking of polymer chains, brought about by electron beams, heat, chemical additives or other means.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this specification, unless the context requires otherwise, the word “comprise”, or variations such as “comprises” or “comprising”, will be understood to imply the inclusion of a stated step or element or integer or group of steps or elements or integers, but not to the exclusion of any other step or element or integer or group of elements or integers. Thus, in the context of this specification, the term “comprising” means “including peripherally, but not necessarily solely”.

Throughout this disclosure, certain embodiments may be disclosed in range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form. part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a laminate will now be disclosed.

In a first aspect, there is provided a process for making a comb-like polymer comprising the following steps:

(a) reacting an epoxy-functionalized monomer with a nucleophile comprising an C₈-C₂₀-alkyl group or halogen substituted C₈-C₂₀-alkyl group in the presence of an aqueous medium; and

(b) polymerizing the reaction product.

As used herein, the term epoxy-functionalized monomer includes both epoxides and functional equivalents of such materials, such as oxazolines. It can be preferably an amphiphilic compound. Examples of epoxy-functional monomers include, but are not limited to, those containing 1,2-epoxy groups. Examples that can be mentioned are glycidyl acrylate and glycidyl methacrylate. Other suitable epoxy-functional monomers include allyl glycidyl ether, glycidyl ethacrylate, glycidyl itoconate, and other glycidyl(meth)acrylates. A glycidyl group carrying acrylate, such as glycidyl methacrylate, is especially preferred. Besides containing the epoxy group the epoxy-functionalized monomer must have a second functionality that allows for polymerisation. Ethylenic and vinylic monomers functionalized with an epoxy group can be especially mentioned. Examples of monomers containing ethylenic and vinylic groups are those non-volatile unsaturated glycidyl compounds which contain one or more double bonds in the middle or in one end of hydrocarbon chain, such as vinyl glycidyl ether, 4-vinylbenzyl glycidyl ether, etc. and long alkyl chain bearing vinyl group, such as dodecyl methacrylate, stearyl methacrylate, 4-ethenyl-2-alkoxyphenol, etc. An acrylate or styrenic group that can be polymerised by free-radical polymerisation under UV radiation can be specifically mentioned as being preferred.

As used herein, the term nucleophile includes all compounds that have a nucleophilic group that can react with an epoxy functionality such as amine, hydroxyl or carboxyl groups. Amine, hydroxyl or carboxyl compounds are preferred.

These compounds comprise a hydrophobic C₈-C₂₀-alkyl group or a halogen substituted C₈-C₂₀-alkyl group. Which means that the nucleophilic group is directly or via a linker bound to these optionally substituted alkyl groups. Preferred according to the invention are optionally halogen substituted C₈-C₂₀-alkylamines, C₈-C₂₀-alcohols or C₈-C₂₀-carboxylic acids.

As used herein, the term “alkyl” includes within its meaning divalent (“alkylene”) straight chain or branched chain saturated aliphatic groups-having from 8 to 20 carbon atoms, e.g., 8, 9, 10, 11, 12, 13, 14 , 15, 16 17, 18, 19, 20 carbon atoms. For example, the term alkyl includes, but is not limited to octyl, nonyl, decyl, undecyl, dodecyl, tridecyl, tetradecyl, pentadecyl, hexadecyl, heptadecyl, octadecyl, nonadecyl and the like. An alkyl group with 12 to 16 carbon atoms is preferred. The alkyl group in the nucleophile can be substituted by one or more halogen atoms such as fluorine chlorine, bromine or iodine. Preferably it is substituted by fluorine. Most preferably it is substituted by several fluorine atoms, such as a perfluoro-group. 1-C₁₂-C₁₈-alkylamines, such 1-Dodecaylamine or 1-Hexadecylamine can be mentioned as a very preferred nucleophile.

The term “reacting in the presence of an aqueous medium” means that water is present in the reaction so that the functional groups (epoxy group and nucleophilic group) can react according to scheme 1. The overall reaction of the epoxy-functionalized monomer with nucleophilic compound can be done in a medium that only partly contains an aqueous medium such as an emulsion. Preferably the nucleophilic compound with the alkyl chain is dispersed in water. A colloidal aggregate is then formed according to one embodiment of the invention wherein the nucleophilic groups are oriented to the aqueous phase and can react with the amphiphilic monomer. An oil in water emulsion can be also mentioned as one preferred embodiment of the invention.

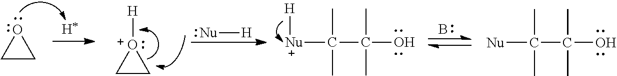

Scheme 1: Schematic example of an alkylation reaction of an epoxide with a nucleophilic group.

Step (a) can be performed at various temperatures with an ambient temperature of 20 to 30° C. being preferred. The reactants can be used in wide ranges, but equimolar ratios may be mentioned as preferred.

The alkylation of the epoxy group with the nucleophile can be supported by adding a catalyst into the aqueous medium. Preferably the catalyst is a strong acid such as HCl or H₂SO₄.

According to another preferred embodiment, step (a) is run under pH controlled conditions. The acid can then be used to adjust the pH in the aqueous medium. The alkylation degree can be adjusted by choosing the pH.

According to one embodiment the pH is adjusted to pH 1-2, preferably 1.4 to 1.6. This can for instance be achieved by using a 0.1 to 0.01 molar HCl solution as the aqueous medium, or preferably a 0.02 to 0.03 molar HCl solution. In such acidic medium there can be achieved a higher akyl side chain density combined with shorter main chain lengths, for instance when using 1-Hexadecylamin (HAD) and glycidyl methacrylat (GMA) to form 3-(hexadecylamino)-2-hydroxypropyl methacrylate (HDA-HPMA). This structure allows to make a hydrophobic dominant comb-like polymer [P(HDA-HPMA)], which is pertinent to the formation of the SHP outmost surface.

According to another embodiment the pH is adjusted to a neutral range. A range of 6.5 to 7.5 can be mentioned with a pH of about 7 being preferred. This can for instance be achieved by avoiding the addition of a strong acid in the aqueous medium. In such neutral aqueous medium there can be achieved a larger average molecular weight and less density of the hexadecyl side chains. This structure allows for instance the main chain (backbone) of P(HDA-HPMA) to be readily accessed in the subsequent polyurethane curing step.

A similar effect of adjusting the alkylation degree and chain length can be achieved by adding salts in reaction step (a) into the aqueous medium. Such salts include, but are not limited to lithium, sodium and potassium chloride.

In step (b) the reaction product of the alkylation can be polymerized to form the comb-like polymer. The polymerisation type depends on the other functionality of the monomer. Typical polymerisation conditions can be chosen.

For some monomers, such as acrylates, a free radical polymerisation is preferred. In this preferred embodiment of the invention the polymerisation is initiated by UV radiation of the reaction mixture.

The reaction product of step (a) can be in-situ polymerized. A one-pot reaction is another embodiment of the invention. Preferably the surface pending amphiphilic groups (e.g. the vinyl groups) formed on the outside of a colloidal aggregate containing the reaction product (e.g. HDA-HPMA) in step (a) can be polymerized in-situ.

Temperatures can vary according to the polymerisation type. Ambient temperature of about 20 to 30° C. can be mentioned for UV light supported polymerisation. Typical reaction times are between about 20 minutes and 4 hours, preferably about 1 hour.

In an alternative embodiment of the invention, the polymerisation in step (b) is a copolymerisation with another polymer monomer in an oil-in-water emulsion and comprising another subsequent step which is a phase inversion treatment. The reaction product of step (a) is then used for co-polymerisation with a polymer monomer in an oil-in-water emulsion and subsequent phase inversion treatment.

The polymer monomer is preferably a monomer with a double bond, such as a vinyl monomer. Styrene is especially preferred as such vinyl monomer. The reaction product from step (a) can for instance be 3-(dodecylamino)-2-hydroxypropyl methacrylate (DDA-HPMA). The copolymerisation takes place in an oil-in-water emulsion between the product of step (a) and the other vinyl monomer. In case of styrene (S) the co-polymer would be P(S-co-DDA-HPMA).

In case of the use of vinyl compounds the polymer monomers, such as styrene, a particle with a vinyl core and a long alky group carrying shell of a comb-like polymer may be obtained. According to the inventive finding this structure is obtainable, because of a high rate of polymerisation of the vinyl compound and slower polymerisation of the polymer obtained in step (a). Such structures can therefore be obtained when the polymerization kinetics of the polymer monomer in the emulsion are different from those of the comb-like polymer.

The copolymerisation can be adapted to the monomer type used. A free radical polymerisation using UV light can be used for vinyl type monomer together with methacrylate products of step (a).

The inversion treatment step is characterized by a phase inversion using a solvent or solvent mixture that has a high solubility for both the polymer monomer used in step (b) and the non-alkyl part of the product of step (a). Applying this solvent in the phase inversion the long alkyl chains will be pulled out and a submicron sphere with another polymer's shell having long alkyl chains as outside “hair” will be obtained. In case that polystyrene is used as the polymer monomer and a long alkyl substituted methacrylate is used as the product of step (a), e.g. (DDA-HPMA), a suitable phase inversion solvent could consist of cyclohexane (θ-solvent of polystyrene) and 2-aminoethanol (resembling HPMA). The submicron sphere is then a P(S-co-DDA-HPMA) sphere with a core and a shell with dodecyl hairs.

In a second aspect, it is provided the comb-like polymer that is obtainable by the method according to the invention and its preferred embodiments. The polymer preferably has a hydrophilic backbone with selected functional groups. In case of P(HDA-HPMA) these groups include hydroxyl, secondary ammonium and epoxide groups on a polymethacrylate backbone. The hydrophobic long alkyl chains are forming the comb's side chains. The obtainable polymer typically has a degree of polymerization of ca. 50 to 100. The ratio of alkyl groups to backbone units can be estimated to be 1 to 2 since it provides a hydrophilic lipophilic balance (HLB) of about 2-5.

In a third aspect there have been provided submicron spheres obtainable in the alternative embodiment using co-polymerisation. The submicron sphere can have a core-shell structure with polymer core and a shell with long alkyl chains. The alkyl side chains (e.g. dodecyl chains in the case of p(S-co-DD-HPMA) can be pulled out of the surface shell through phase inversion treatment. As a result, the resulting submicron spheres have a shell of a comb-like polymer. They provide interesting structural features which can be utilized. For instance they can be integrated with the comb-like polymers to fabricate a rough, soft SHP surfaces. The submicron spheres with the shell have a particle size of 500-1000 nm.

In a fourth aspect there is provided another alternative process for making a comb-like polymer comprising the following steps

(b) polymerizing an epoxy-functionalized monomer optionally in the presence of another monomer to form a polymer or co-polymer; and

(a) reacting the polymer or co-polymer with a nucleophile comprising an C₈-C₂₀-alkyl group or halogen substituted C₈-C₂₀-alkyl group in an emulsion.

The epoxy-functionalized polymer is the same as mentioned above, but is already polymerised before the nucleophilic reaction with the long alkyl chain nucleophile according to this alternative. The polymerisation in step (b) can be a polymerisation as described above. A radical polymerisation using a free-radical polymerisation initiator is preferred. A reaction in emulsion form is preferred. A typical free-radical initiator that can be mentioned includes 2,2′-azobis(amidinopropane) dihydrochloride (V50), but is not limited thereto. The free-radical initiator is preferably used at a rate of 0.1 to 0.3% by weight of the monomers.

In one embodiment at least one other monomer is used in the polymerisation of step (b). Preferably this is a vinyl polymer which can have one or more vinyl functionalities, such as styrene (St) or divinylbenzene (DVB). The styrene and divinyl benzene ratio can even be used to create a polymer backbone of desired cross-linking. This mixture of polymers can preferably be used to make sub-micron spheres with a hairy surface after free-radical polymerisation. After polymerisation the alkyl chain (“hair”) is added via step (a). According to the invention a mixture of St, DVB and GMA can be used with water as the dispersion medium in step (b) then. Preferred mixing ratio by weight of St/DVB/GMA in such solution are 1-20% St, 0-5% DVB, V50 (0.1 to 0.3% of the three monomers) and 74.7 to 89.9% of dispersion medium. A mixing ratio of the monomers about 10:1:1 to 4:0.5:1 can be particularly mentioned. A ratio of about 6.6:0.7:1 is most preferred.

Temperatures can vary in step (b) according to the polymerisation type. Elevated temperatures of about 60 to 90° C. can be mentioned for free-radical initiated polymerisation. Typical reaction times are between about 1 hour and 48 hours, preferably about 24 hours.

The polymer obtained in this step (b) of the alternative process can be isolated by typical means, such centrifugation and drying.

In the next step (a) the reaction can be run in emulsion or dispersion.

Reaction temperatures can vary in step (a) according to the polymerisation type. Elevated temperatures of about 80 to 130° C. can be mentioned for reaction in organic solvents. Typical reaction times are between about 1 hour and 48 hours, preferably about 24 hours.

The polymer obtained in step (b) can be isolated by typical means, such as centrifugation and drying.

In a fifth aspect, there is disclosed the use of the comb-like polymer of the method according to the invention in a coating process characterized in that a polyurethane pre-polymer is cured in the presence of the comb-like polymer.

Polyurethane prepolymers are obtained by partly reacting a polyol with a diisocyanate. In this regard a not fully cured polyurethane is obtained that may still contain free diisocyanates. The amount of free diisocyanate will depend on the ratio of hydroxyl/isocyanate and the relative reactivity of the first and second isocyanate on a diisocyanate. In some commercially prepared prepolymers the excess of free diisocyanate has been removed by thin film evaporation. Although these special prepolymers are higher in cost, they are saver to handle. According to the invention all available prepolymers can be used.

Polyurethane prepolymers which can be used as top coats are particularly preferred. They usually have a high solid content. As such there can be mentioned the commercial polyurethanes Desothane® HS made by PPG Aerospace Huntsville, Ala. 35811 USA or Eclipse® HS made by Akzo Nobel Aerospace Coatings, a division of International Paint LLC (USA), East Water Street, Waukegan, Ill. 60085, USA).

Preferably the prepolymer is used in a mixture with a curing agent or activator. Preferably a thinner can be additionally used in this mixture.

Typical mixing ratios of polyisocyanate monomer/polyol/thinner that can be mentioned are about 4:2:4 to 1:0.5:4, most preferably 2:1:4.

Curing agents and thinner can be those known from the literature/commercial information of the manufacturer for the specific polyurethane employed and are not limited to, any compounds. Curing agents either support the curing or increase the adhesion during curing. Thinners are used to decrease the viscosity of the polymer solution for brush and spread coating. Typical curing agents for forming a polyurethane network include organic tin, e.g. dilauryl diisobutyrate tin, and tertiary amines. Thinners used to formulate commercial isocyanates paints to form polyurethane are normally mixtures of p/o/m-xylenes, ethyl or butylacetate and alkyl ketone.

The curing can occur at ambient temperature (about 20-30° C.) or at elevated temperatures of above 30° C., e.g. 30 to 70° C.

The polyurethane prepolymer can then be cured in a mixture optionally comprising a curing agent (or activator), a thinner and the comb-like polymer according to one embodiment of the invention. In a preferred embodiment according to the invention the polyurethane prepolymer is first pre-cured in the presence of comb-like polymer obtainable by the inventive process run under neutral condition and then fully cured in the presence of a thinner and a polymer obtainable by the inventive process run under acidic condition.

For pre-curing with comb-like polymer obtainable by the inventive process run under neutral condition, the preferred content of comb-like polymer is 25-55% by weight of the coating mixture, most preferably 30-40% . For final curing with comb-like polymer obtainable by the inventive process run under neutral condition, the preferred content is 0.1-5% by weight of the coating mixture, most preferably 0.4 to 2%.

The coatings can be applied by typical methods in the coating applications. The pre-curing coating can for instance be applied by dip-coating or spraying. The final coating for the outer surface can be preferably applied by spin-coating.

The comb-like polymer obtainable by the inventive process run under neutral condition is characterized by a comparatively larger molecular weight and less dense long alkyl side chains, while the comb-like polymer obtainable by the inventive process run under neutral condition is characterized by a comparatively lower molecular weight and less dense long alkyl side chains. By the use of these polymers according to this embodiment a particularly preferred coating can be obtained with a SHP surface. This use constitutes therefore a method applying a favourable gradient implantation process for including the inventive polymers into a polyurethane surface with improved SHP surface.

Preferably the pre-curing step is run as partial curing and then a dilute solution of the second comb-like polymer, alone or in combination with the sub-micro spheres according to the invention, together with the thinner is applied to it and then fully cured. This approach is for instance suited to first bind the P(HDA-HPMA)with lower alkyl side chain density into the polyurethane framework utilizing the hydroxyl, secondary amino and epoxide groups of the backbone. In a second step the P(HAD-HPMA) molecules with high long alkyl chain density are grafted to the coating with the assistance of the thinner swelling effect during the final full curing.

During the process, especially in the final curing phase with assistance of the swelling, additives can be added which further increase the SHP of the surface. Such additives for the increase of the hydrophobicity can be e.g., tailored nano-particles or rubber, such as chloro/fluoro rubber segments. Their content typically is 0.1 to 3% in coating composition for the most outer layer. Nanoparticles that can be mentioned as an example without limitation thereto include inorganic silica, tin oxide, alumina and zinc oxide nanoparticles. Their size is usually 1 to 200 nm, preferably 5 to 100 nm.

As chloro/fluoro rubber segments there can be mentioned as an example without limitation thereto oligomers of poly(chloro isoprene) and fluorinated polyacrylate.

A close-packed thin layer on a polyurethane coating can be achieved according to the invention.

In another embodiment of the invention, the inventive use is one wherein for the full curing a mixture of the polymer obtainable according to the process run under acidic conditions and the inventive submicron sphere obtainable according to the invention is used. Typical ratios of using a comb-like polymer made under acidic conditions and the spheres are within the weight ratio of 100/5.

This coating obtainable by the use of the comb-like polymers forms the sixth aspect of the invention. This surface itself in-turn functions as a bed for accommodating the above mentioned additives for increasing the hydrophobicity, because of the chain-entanglement fixing effect.

In a seventh aspect, there is provided the use of the polyurethane coatings obtainable according to the invention as top coat on aircraft wings or as water repellent surface coating of pipes or ship bodies. In these applications the advantageous features of the inventive coatings can be utilized to improve the lifetime of the SHP effect and ensure a good adhesion.

A superhydrophobic coating is important to help aircraft fly safely through icy weather. The build-up of ice as super-cooled liquid water collected on surface with lower airflow can affect the aerodynamics of the aircraft and thus flight control.

The current invention provides means in incorporating a cost effective and scalable technique easily into the existing and matured aerospace coating surface, such as urethane coatings.

In the same way the inventive coatings can be used to serve as water repellent surface coatings of pipes or ship bodies.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 shows a microscopic image of water droplet on pristine polyurethane based paint (a), and a modified surface (b) according to example 3.

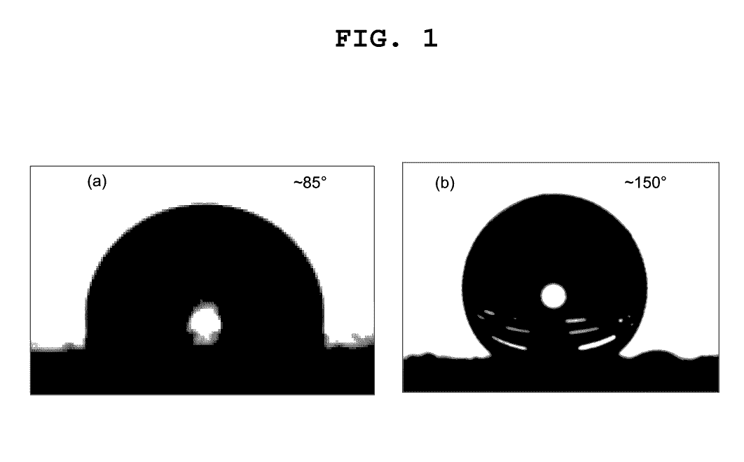

### EXAMPLES

Non-limiting examples of the invention and a comparative example will be further described in greater detail by reference to specific Examples, which should not be construed as in any way limiting the scope of the invention.

### Example 1

### Preparation of P(HAD-HPMA) under Acidic Conditions

An aqueous solution of HCl (0.025M) was used as a dispersion medium to prepare a mixture by introducing equal molar GMA and HAD into it, in which the content of the GMA and HAD was 25-30% by weight. The cloudy mixture was stirred vigorously at 1000 rpm for 1-2 min to form a concentrated emulsion. It was further homogenized by using a vortex homogenizer for 20 seconds. After that, equal volume of the HCl aqueous solution was added into the emulsion and vortexed for about 15 min to ensure homogenous mixing. The resulting gel-like emulsion of about 30 g was then placed in a Rayonet UV Reactor (RPR-100) to carry out UV irradiation for 1 h to polymerize GMA. A semi-solid yellow mixture was obtained and subjected to incubating in an oven at 60° C. for 3 days. Then the resulting dried solid was dispersed in ethanol to wash away unreacted compounds. The suspension was centrifuged and washed in ethanol for 2 more times. Finally a white solid, P(HAD-HPMA), was attained.

### Example 2

### Preparation of P(HAD-HPMA) under Neutral Conditions

This synthesis followed the same procedure as the above except the use of water instead of HCl aqueous solution as dispersion medium.

### Example 3

### Preparation of SHP Surface on Polyurethane Paint using P(HAD-HPMA) of Examples 1 and 2

A commercial polyurethane (PPG, Desothane® HS) topcoat paint consists of component 1, a polyisocyanate monomer, and component 2, a polyol together with an activator being added to form a hard, glossy and inert polyurethane network. Components 1 and 2 and a thinner were mechanical mixed by the weight ratio of 2:1:4, then P(HAD-HPMA) of example 2 (40% of the paint mixture) was blended in. The resulting formulation was then applied to the substrate by dip-coating. The coating was dried at ambient condition (25° C. and in air) for 3 h. Subsequently, a solution of P(HAD-HPMA) of example 1 (0.5% by weight) and a rubber (ca. 1%) in toluene was spin-coated (˜100 rpm) to the surface. Lastly, the resulting coating was allowed for drying at ambient condition for 24 h to complete formation of the desired topcoat.

### Example 4

### Preparation of Sub-Micron Spheres through Inversion Phase Reaction

Styrene (St), the addition reaction product from (a), i.e. HAD-HPMA, and a free-radical polymerization initiator, benzoyl peroxide (BPO, purchased from Aldrich) were dissolved in N,N-dimethylformaldehyde (DMF) in a round-bottom reaction flask (200 ml). The mixture consists of 20% St, 15% (HAD-HPMA), 0.15% BPO and 65% DMF with a total volume of 120 ml. The flask was purged with Ar and then heated to 70° C. with magnetic stirring (300-400 rpm) for 24 h to carry out polymerization. After that, the random co-polymer P(St-HAD-HPMA) was obtained and separated by precipitating it from the polymerization mixture through introducing the mixture in excess water. After washing the solid in ethanol, the P(St-HAD-HPMA) solid was dissolved in cyclohexane at 50° C. to form a 10% solution with a volume of 50 ml, for example. Then 10 ml decane and 0.3 g span-80 (an non-ionic surfactant) was introduced into the mixture with vigorous stirring (600 rpm) and the resulting mixture was cooled down to about 0-5° C. at which phase inversion nucleation takes place to form submicron spheres with alkyl chains on surface and aggregation of St units inside. The solid precipitate was separated by high-speed centrifugation from the liquid medium and washed with ethanol. Finally the solid was vacuum dried at room temperature for a day.

### Example 5

### Preparation of Sub-Micron Spheres through Inversed Reaction

### Synthesis of Poly(Styrene-Divinylbenzene-Glycidylmethacrylate) Submicron Spheres by Emulsion Polymerization

Styrene (St), divinylbenzene (DVB), glycidylmethacrylate (GMA) and a free-radical polymerization initiator (V50) were dispersed in water. The mixture consists of 8.6% St, 0.95% DVB, 1.3% GMA, 0.15% V50 and 89% pure water. It was then emulsified in a round-bottom flask by magnetic stirring (600 rpm) in Ar and heated to 70° C. to conduct polymerization for 24 h. After that, the polymer powder was separated by high-speed centrifugation (9500 rpm) for 30 min from the polymerization mixture and was subsequently washed in ethanol. This purification step was repeated three times. The recovered powder, P(St-DVB-GMA), was dried in an oven at 40° C. for one day.

### Synthesis of P(StDVB-GMA)-ODA Hairy Submicron Particles

In a single-necked round bottom flask P(St-DVB-GMA) powder and octadecylamine-1 (ODA) were added in DMF to form a suspension with the contents of the three components in order of 6.7%, 3.3%, and 90%, respectively. The suspension was then subjected to ultrasonicating for 30 min until a homogeneous emulsion was formed. The emulsion was heated to 110° C. for 24 h to carry out alkylation of ODA on the P(St-DVB-GMA) submicron spheres. After reaction, the resulting P(St-DVB-GMA)-ODA hairy particles were separated from the reaction mixture by centrifugation (8500 rpm) for 30 min. The powder was washed and in ethanol and centrifuged repeatedly for 4 cycles. The collected white powder was dried under vacuum at 40° C. for 24 h.

### Applications

The disclosed process provides new comb-like polymers with a backbone with functional groups and hydrophobic side chains. It also provides sub-micron sphere with a shell that caries alkyl side chains and functional groups.

Both the comb-like polymers as well as the submicron spheres can be used during the making of polyurethane coatings and achieve a desirable SHP surface of the coating according to the invention.

Such polyurethane coatings can be used as paints in many applications where super hydrophobicity is desirable. Such application includes for instance aircraft wing coatings or coatings for ships and pipes.

However, due to their unique structure the polymers obtained by the inventive process may have more uses.

It will therefore be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A process for making a comb-like polymer comprising the following steps:
(a) reacting an epoxy-functionalized monomer with a nucleophile comprising a C₈-C₂₀-alkyl group or halogen substituted C₈-C₂₀-alkyl group in the presence of an aqueous medium; and
(b) polymerizing the reaction product.

2. The process according to claim 1 wherein the epoxy-functionalized monomer is a glycidyl group carrying acrylate.

3. The process according to claim 2 wherein the polymerization is a free radical polymerization.

4. The process according to claim 3 wherein the nucleophile is an amine, hydroxyl or carboxyl compound.

5. The process according to claim 1 wherein the epoxy-functionalized monomer is glycidyl methacrylate and the nucleophile is 1-hexadecylamine.

6. The process according to any of claims 1 to 5 wherein step (a) is run under controlled pH conditions.

7. The process according claim 6 wherein the pH is about 1.0 to 2.0.

8. . The process according to claim 6 wherein the pH is about 6.5 to 75.

9. The process according to any of claims 1 to 5 wherein in step (a) a salt is added.

10. The process according to claim 1 wherein the polymerisation of the reaction product of step (a) takes place in an emulsion.

11. The process according to claim 1 or 10 wherein the polymerisation in step (b) is a copolymerisation with another polymer monomer in an oil in water emulsion and comprising another subsequent step which is a phase inversion treatment.

12. A process for making a comb-like polymer comprising the following steps
(b) polymerizing an epoxy-functionalized monomer optionally in the presence of another monomer to form a polymer or co-polymer; and
(a) reacting the polymer or co-polymer with a nucleophile comprising an C₈-C₂₀-alkyl group or halogen substituted C₈-C₂₀-alkyl group in an emulsion.

13. The process according to claim 12 wherein a vinyl monomer is used in step (b).

14. A comb-like polymer obtainable by a method according to any of claims 1 to 13.

15. A submicron sphere with a comb-like polymer shell obtainable according to the process of claim 11 or 14.

16. Use of the comb-like polymer according to claim 14 in a coating process characterized in that a polyurethane pre-polymer is cured in the presence of the comb-like polymer.

17. The use according to claim 16 wherein the polyurethane prepolymer is first pre-cured in the presence of comb-like polymer obtainable according to the process of claim 8 and then fully cured in the presence of a thinner and a polymer obtainable according to the process of claim 7.

18. The use according to claim 15 wherein for the full curing a mixture of the polymer obtainable according to the process of claim 7 and the sphere obtainable according to claim 15 is used.

19. A coating obtainable by the method of any of claims 16 to 18.

20. A. coating according to claim 19 additionally including additives for the increase of hydrophobicity.

21. Use of a coating according to claim 19 or 20 as top coat on aircraft wings.

22. Use of a coating according to claim 19 or 20 as water repellent surface coating of pipes or ship bodies.
